(19) United States
(12) Patent Application Publication
(10) Pub. No.: US 2018/0098131 A1
(43) Pub. Date: Apr. 5, 2018

(54) APPARATUS AND METHODS FOR ADAPTIVE BIT-RATE STREAMING OF 360 VIDEO

(71) Applicant: Avago Technologies General IP (Singapore) Pte. Ltd., Singapore (SG)

(72) Inventor: Minhua Zhou, San Diego, CA (US)

(73) Assignee: Avago Technologies General IP (Singapore) Pte. Ltd., Singapore (SG)

(21) Appl. No.: 15/711,704

(22) Filed: Sep. 21, 2017

Related U.S. Application Data
(60) Provisional application No. 62/402,344, filed on Sep. 30, 2016.

(51) Int. Cl. H04N 21/6373; H04N 21/2343; H04N 21/81

(52) U.S. Cl. CPC H04N 21/6373; H04N 21/816; H04N 21/23439

(57) ABSTRACT

In some aspects, the disclosure is directed to methods and systems for providing 360-degree video. One or more viewport engines receives 360-degree video data, and generates a plurality of versions of the 360-degree video data. Each version has a corresponding primary viewing direction, independently decodable units (IDUs) of video data arranged according to a sequence, and image resolution for the corresponding primary viewing direction that is higher than image resolutions for other viewing directions. A streaming server streams a first IDU of video content from a first version of the plurality of versions of the 360-degree video data to a client for rendering at the client, and receives feedback according to the rendering at the client. Responsive to the update in viewing direction, the streaming server dynamically switches to a second version of the plurality of versions that has a primary viewing direction comprising the second viewing direction.

### CROSS REFERENCE TO RELATED APPLICATIONS

This application claims priority to and the benefit of U.S. Provisional Application No. 62/402,344, filed Sep. 30, 2016, entitled “APPARATUS AND METHODS FOR ADAPTIVE BIT-RATE STREAMING OF 360 VIDEO”, assigned to the assignee of this application, and which is incorporated herein by reference in its entirety for all purposes.

### FIELD OF THE DISCLOSURE

The present description relates generally to systems and methods for adaptive bit-rate streaming, including but not limited to systems and methods for adaptive bit-rate streaming of 360 video.

### BACKGROUND OF THE DISCLOSURE

360 videos, also known as 360-degree video, immersive videos, or spherical videos, are video recordings of a real-world panorama, where the view in every direction is recorded at the same time, shot using an omnidirectional camera or a collection of cameras. During playback, a viewer can have control of the viewing direction and Field of View (FOV) angles, as a form of virtual reality.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 depicts a diagram of a 360 degree video capture and playback system according to some example embodiments.

FIG. 2 depicts a diagram of a 360 viewing coordinate system according to some example embodiments.

FIG. 3 depicts a diagram of rotation angles of a 3D viewing coordinate system according to some example embodiments.

FIG. 4 depicts a viewport based 360 video streaming system according to some example embodiments.

FIG. 5 depicts a rectangular prime projection format for 360 viewport according to some example embodiments.

FIG. 6 depicts a truncated pyramid projection format for 360 viewport according to some example embodiments.

FIG. 7 depicts a representation of 360 viewport generation and encoding according to some example embodiments.

FIG. 8 depicts viewport based ABR streaming according to some example embodiments.

FIG. 9 depicts a flow chart of a method for streaming 360-degree video data according to some example embodiments.

The details of various embodiments of the methods and systems are set forth in the accompanying drawings and the description below.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more implementations.

In one aspect, this disclosure is directed to a system for streaming 360-degree video data. In one or more embodiments, the system includes one or more viewport engines and a streaming server. In one or more embodiments, the one or more viewport engines receive 360-degree video data, and generate a plurality of versions of the 360-degree video data. In one or more embodiments, each version has a corresponding primary viewing direction, includes independently decodable units (IDUs) of video data arranged according to a sequence, and has image resolution for the corresponding primary viewing direction that is higher than image resolutions for other viewing directions. In one or more embodiments, the streaming server streams a first IDU of video content from a first version of the plurality of versions of the 360-degree video data to a client for rendering at the client. In one or more embodiments, the first version has a primary viewing direction comprising a first viewing direction. In one or more embodiments, the streaming server receives feedback according to the rendering at the client. In one or more embodiments, the feedback is indicative of an update in viewing direction to a second viewing direction. In one or more embodiments, responsive to the update in viewing direction, the streaming server dynamically switches to a second version of the plurality of versions that has a primary viewing direction comprising the second viewing direction, to stream one or more IDUs from the second version to the client. In one or more embodiments, the one or more IDUs are streamed according to the sequence relative to the first IDU.

In one or more embodiments, the one or more viewport engines generate IDUs of the first and second versions for streaming at a first bit rate. In one or more embodiments, the first bit rate is a function of an image resolution and a frame rate of the IDUs of the first and second versions. In one or more embodiments, the one or more viewport engines generate the plurality of versions of the 360-degree video data by generating a first plurality of versions according to a first bit rate for streaming, and a second plurality of versions according to a second bit rate for streaming.

In one or more embodiments, the streaming server detects a change in network condition, and to dynamically switch from the first version to the second version responsive to the detected change in network condition. In one or more embodiments, the first version is from the first plurality of versions, and the second version is from the second plurality of versions. In one or more embodiments, the streaming server detects a change in network condition, and to dynamically switch from the second version to a third version, responsive to the detected change in network condition. In one or more embodiments, the second version is from the first plurality of versions, and the third version is from the second plurality of versions, and the second and third versions each has a primary viewing direction comprising the second viewing direction.

In one or more embodiments, each IDU of the first version includes video data for which a typical field-of-view (FOV) angle centered around the corresponding primary viewing direction has a first image resolution, and video data for other viewing directions each has an image resolution that is lower than the first image resolution. In one or more embodiments, the system includes one or more storage devices configured to store the generated plurality of versions of the 360-degree video data. In one or more embodiments, the streaming server further retrieves the first IDU from the one or more storage devices to stream to the client.

In another aspect, this disclosure is directed to a method for streaming 360-degree video data. In one or more embodiments, 360-degree video data is received. In one or more embodiments, a plurality of versions of the 360-degree video data is generated. In one or more embodiments, each version has a corresponding primary viewing direction, with independently decodable units (IDUs) of video data arranged according to a sequence, and has image resolution for the corresponding primary viewing direction that is higher than image resolutions for other viewing directions. In one or more embodiments, a streaming server streams a first IDU of video content from a first version of the plurality of versions of the 360-degree video data to a client for rendering at the client. In one or more embodiments, the first version has a primary viewing direction comprising a first viewing direction. In one or more embodiments, the streaming server receives feedback according to the rendering at the client. In one or more embodiments, the feedback is indicative of an update in viewing direction to a second viewing direction. In one or more embodiments, responsive to the update in viewing direction, the first version is dynamically switches to a second version of the plurality of versions that has a primary viewing direction comprising the second viewing direction, to stream one or more IDUs from the second version to the client. In one or more embodiments, the one or more IDUs are streamed according to the sequence relative to the first IDU.

In one or more embodiments, IDUs of the first and second versions are generated for streaming at a first bit rate. In one or more embodiments, the first bit rate is a function of an image resolution and a frame rate of the IDUs of the first and second versions. In one or more embodiments, generating the plurality of versions of the 360-degree video data includes generating a first plurality of versions according to a first bit rate for streaming, and a second plurality of versions according to a second bit rate for streaming. In one or more embodiments, a change in network condition is detected. In one or more embodiments, the first version is dynamically switched to the second version responsive to the detected change in network condition. In one or more embodiments, the first version is from the first plurality of versions, and the second version is from the second plurality of versions.

In one or more embodiments, another change in network condition is detected. In one or more embodiments, the second version is dynamically switched to a third version, responsive to the detected change in network condition. In one or more embodiments, the second version is from the first plurality of versions, and the third version is from the second plurality of versions, and the second and third versions each has a primary viewing direction comprising the second viewing direction. In one or more embodiments, each IDU of the first version comprises video data for which a typical field-of-view (FOV) angle centered around the corresponding primary viewing direction has a first image resolution, and video data for other viewing directions each has an image resolution that is lower than the first image resolution. In one or more embodiments, the generated plurality of versions of the 360-degree video data are stored in one or more storage devices. In one or more embodiments, the first IDU is retrieved from the one or more storage devices to stream to the client.

In yet another aspect, this disclosure is directed to one or more computer-readable storage media having instructions stored therein that, when executed by at least one processor, cause the at least one processor to perform operations including: receiving 360-degree video data; generating a plurality of versions of the 360-degree video data, each version having a corresponding primary viewing direction, each version comprising independently decodable units (IDUs) of video data arranged according to a sequence, and having image resolution for the corresponding primary viewing direction that is higher than image resolutions for other viewing directions; streaming a first IDU of video content from a first version of the plurality of versions of the 360-degree video data to a client for rendering at the client, the first version having a corresponding primary viewing direction comprising a first viewing direction; receiving feedback according to the rendering at the client, the feedback indicative of an update in viewing direction to a second viewing direction; and responsive to the update in viewing direction, dynamically switching to a second version of the plurality of versions that has a primary viewing direction comprising the second viewing direction, to stream one or more IDUs from the second version to the client, the one or more IDUs streamed according to the sequence relative to the first IDU.

In one or more embodiments, the at least one processor further performs operations including generating IDUs of the first and second versions for streaming at a first bit rate. In one or more embodiments, the first bit rate is a function of an image resolution and a frame rate of the IDUs of the first and second versions. In one or more embodiments, generating the plurality of versions of the 360-degree video data includes generating a first plurality of versions according to a first bit rate for streaming, and a second plurality of versions according to a second bit rate for streaming.

In one or more embodiments, in ABR streaming, a video content is encoded into multiple layers of streams with different picture resolutions, bit-rates, and frame-rates. Each bitstream includes multiple independently decodable units (IDUs), which allows clients to conduct bitstream switching among the streams based on network conditions, in one or more embodiments. The bitstream switch happens at IDU boundaries, and an IDU lasts for or extends over a period of time (e.g., 1 to 2 seconds) in one or more embodiments. For example, a video content is encoded and stored into three layers, namely 2160p@50 at 8 Mbps, 1080p@50 at 4 Mbps and 720p@30 at 1 Mbps, in one or more embodiments. A stream to the clients is made up of IDUs selected from the three layers of the streams, in one or more embodiments. The stream includes IDUs with different picture resolutions, bit-rates, and frame-rates, in one or more embodiments.

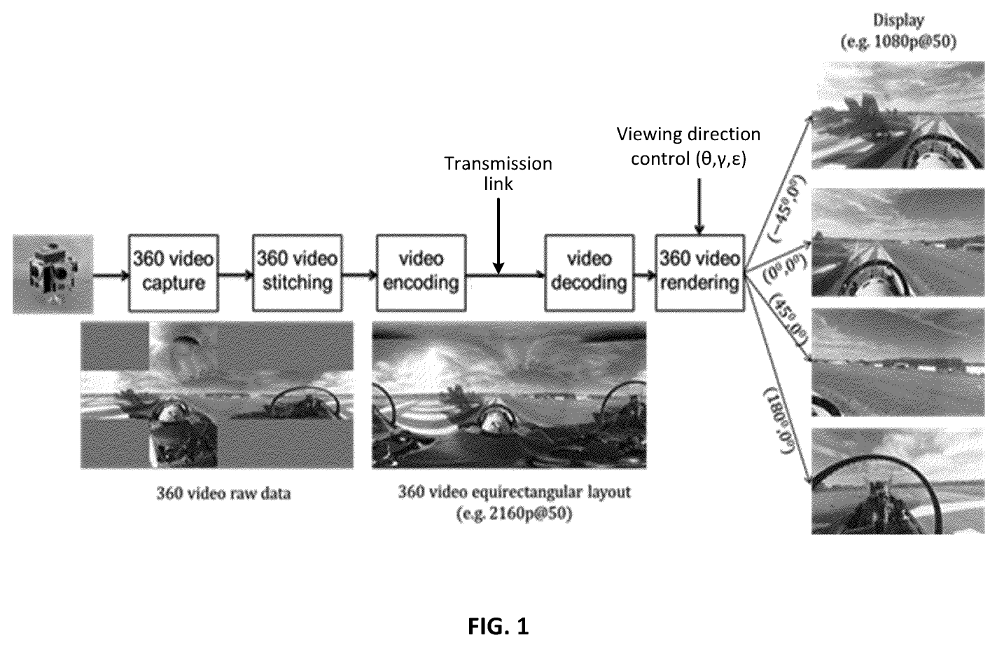

Referring to FIG. 1, a diagram of a 360 degree video capture and playback system is depicted according some example embodiments. A 360 degree video is captured by a camera rig, in one or more embodiments. For example, the 360 video is captured by 6 (or some other number of) cameras stitched together into an equirectangular projection format, in one or more embodiments. The 360 video is compressed into any suitable video compression format, such as MPEG/ITU-T AVC/H.264, HEVC/H.265, VP9, in one or more embodiments. The compressed video is transmitted to receivers via various transmission links, such as cable, satellite, terrestrial, internet streaming, in one or more embodiments. On the receiver side, the video is decoded and stored in e.g. the equirectangular format, then is rendered according to the viewing direction angles and field of view (FOV) angles, and/or displayed, in one or more embodiments. According to one or more embodiments, the clients have control of viewing direction angles and FOV angles in order to watch the 360 video at the desired view direction angles and FOV angles. For ABR streaming, a 360 video content is compressed at several bit-rates, picture sizes and frame-rates to adapt to the network conditions, in one or more embodiments.

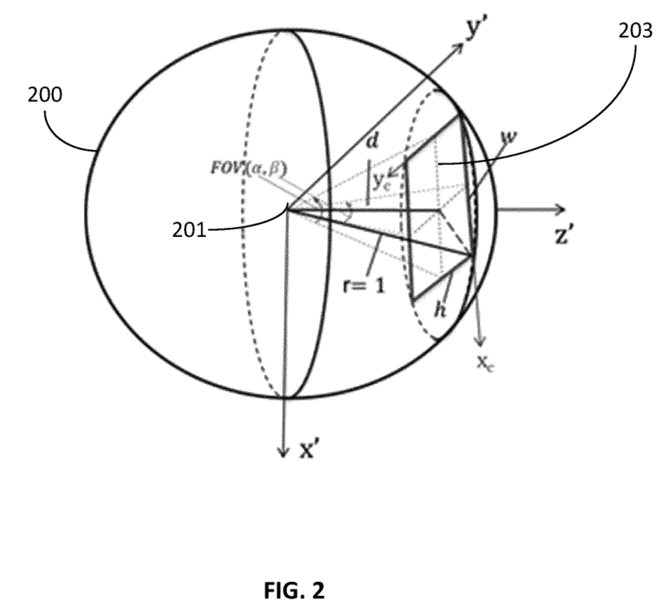

Referring to FIG. 2, a diagram of a 360 viewing coordinate system is depicted according to some example embodiments. For display of a 360 degree video, a portion of each 360 degree video picture is projected and rendered, in one or more embodiments. The FOV angles define how big a portion of a 360 degree video picture is displayed, while the viewing direction angles defines which portion of the 360 degree video picture is displayed, in one or more embodiments. For example, a 360 video is mapped on a sphere surface (e.g., sphere radius is 1) as shown in a 360 viewing coordinate system (x′, y′, z′) depicted in FIG. 2. A viewer at the center point 201 of the sphere 200 is able to view a rectangular screen 203, and the screen has its four corners located on the sphere surface.

As shown in FIG. 2, in the viewing coordinate system (x′, y′, z′), the center point 201 of the projection plane (e.g., the rectangular screen) is located on z′ axis and is parallel to x′-y′ plane, in one or more embodiments. Therefore, in one or more embodiments, the projection plane size, w×h, and its distance to the center of the sphere d can be computed by:

$$\{ \begin{matrix}w = \frac{2 ta}{\sqrt{{ta}^{2} + {tb}^{2} + 1}} \\ h = \frac{2 tb}{\sqrt{{ta}^{2} + {tb}^{2} + 1}} \\ d = \frac{1}{\sqrt{{ta}^{2} + {tb}^{2} + 1}}\end{matrix}$$

Where

$$ta = tan ( \frac{α}{2} ) and tb = tan ( \frac{β}{2} ) ,$$

and αε(0: π] is the horizontal FOV angle and βΣ(0: π] is the vertical FOV angle, respexctively.

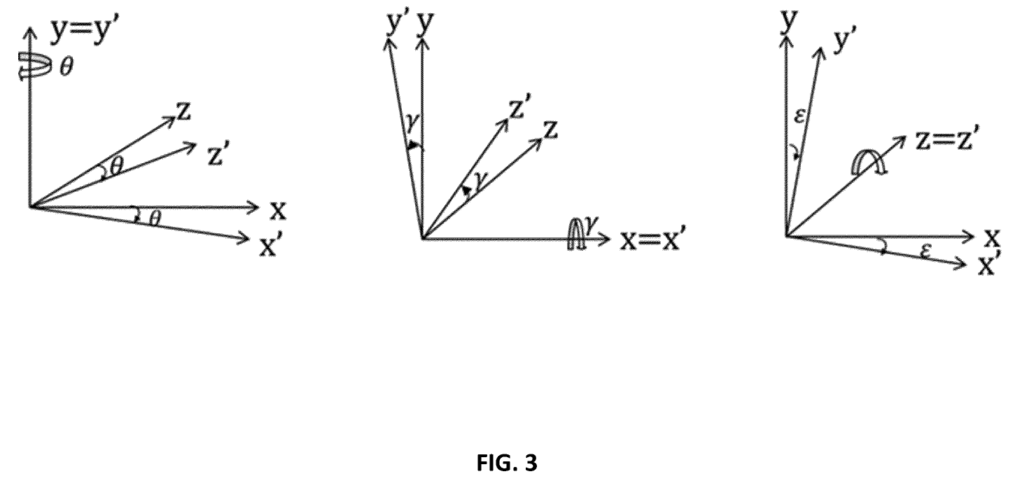

Referring to FIG. 3, a diagram of rotation angles of a 3D viewing coordinate system is depicted according to some example embodiments. As mentioned above and shown in FIG. 1 for example, the viewing direction angles (θ, γ, ε) define which portion of the 360 degree video picture is displayed, in one or more embodiments. The viewing direction is defined by the rotation angles of the 3D viewing coordinate system (x′, y′, z′) relative to the 3D capture (camera) coordinate system (x, y, z), in one or more embodiments. The viewing direction is dictated by the clockwise rotation angle θ along y axis (yaw), the counterclockwise rotation angle γ along x axis (pitch), and the counterclockwise rotation angle ε along z axis (roll), in one or more embodiments.

In one or more embodiments, the coordinate mapping between the (x, y, z) and (x′, y′, z′) coordinate system is defined as:

$$[ \begin{matrix}x \\ y \\ z\end{matrix} ] = [ \begin{matrix}cos θ & 0 & sin θ \\ 0 & 1 & 0 \\ - sin θ & 0 & cos θ\end{matrix} ] [ \begin{matrix}1 & 0 & 0 \\ 0 & cos γ & sin γ \\ 0 & - sin γ & cos γ\end{matrix} ] [ \begin{matrix}cos ϵ & sin ϵ & 0 \\ - sin ϵ & cos ϵ & 0 \\ 0 & 0 & 1\end{matrix} ] [ \begin{matrix}{x}^{′} \\ {y}^{′} \\ {z}^{′}\end{matrix} ]$$

### That is:

$$[ \begin{matrix}x \\ y \\ z\end{matrix} ] = [ \begin{matrix}\begin{matrix}cos θ cos ϵ + \\ sin θsin γ sin ϵ\end{matrix} & \begin{matrix}cos θ sin ϵ - \\ sin θsin γ cos ϵ\end{matrix} & sin θ cos γ \\ - cos γ sin ϵ & cos γ cos ϵ & sin γ \\ \begin{matrix}- sin θ cos ϵ + \\ cos θ sin γ sin ϵ\end{matrix} & \begin{matrix}- sin θ sin ϵ - \\ cos θ sin γ cos ϵ\end{matrix} & cos θ cos γ\end{matrix} ] [ \begin{matrix}{x}^{′} \\ {y}^{′} \\ {z}^{′}\end{matrix} ]$$

One operation of 360 video rendering (for display) is to find the corresponding reference sample(s) in an input 360 video picture for a sample in the output rendering picture, in one or more embodiments. In one or more embodiments, if the rendering picture size is renderingPicWidth×renderingPicheight and an integer-pel coordinate of a rendering sample in the rendering picture is (X_{c}, Y_{c}), then coordinate of the rendering sample in the normalized rendering coordinate system is computed by

$$\{ \begin{matrix}{x}_{c} = \frac{( {X}_{c} + 0.5 ) * w}{renderingPicWidth} \\ {y}_{c} = \frac{( {Y}_{c} + 0.5 ) * h}{renderingPicHeight}\end{matrix}$$

In one or more embodiments, the mapping of the simple to 3D viewing coordinate system (x′, y′, z′) is computed by

$$\{ \begin{matrix}{x}^{′} = {x}_{c} - \frac{w}{2} \\ {y}^{′} = - {y}_{c} + \frac{h}{2} \\ {z}^{′} = d\end{matrix}$$

In one or more embodiments, another step is to use the above relationship between the (x, y, z) and (x′, y′, z′) coordinate system to covert the 3D coordinate (x′, y′, z′) to the (x, y, z) capture (camera) coordinate system. In one or more embodiments, the coordinate(s) of corresponding reference sample(s) in the input 360 video picture is computed based on the 360 video projection format (e.g., equirectangular) and/or the input picture size. In one or more embodiments, the coordinate of corresponding reference sample, i.e. (Xp, Yp), in the input 360 video picture of equirectangular projection format is computed by

$$\{ \begin{matrix}Xp = ( \frac{arc tant 2 ( x , y )}{2 π} + 0.5 ) * inputPicWidth \\ Yp = ( - \frac{arc sin ( \frac{y}{\sqrt{{x}^{2} + {y}^{2} + {z}^{2}}} )}{π} + 0.5 ) * inputPicHeight\end{matrix}$$

Where inputPicWidth×inputPicheight is input 360 picture size of luminance or chrominance components. Note that (Xp, Yp) are in sub-pel precision and the reference sample at (Xp, Yp) may not physically exist in the input 360 video picture as it contains samples only at integer-pel positions, in one or more embodiments.

In one or more embodiments, the coordinate mapping process described above is performed separately for luminance and chrominance components of a rendering picture, or performed jointly by re-using the luminance coordinate mapping for chrominance components based on the Chroma format (coordinate scaling is used for Chroma format such as 4:2:0).

In one or more embodiments, rendering a sample of the output rendering picture is realized by interpolation of reference sample(s) of integer-pel position surrounding the sub-pel position (Xp, Yp) in the input 360 video picture. In one or more embodiments, the integer-pel reference samples used for interpolation are determined by the filter type used. For example, if the bilinear filter is used for interpolation, then the four reference samples of integer-pel position which are nearest to the sub-pel position (Xp, Yp) are used for rendering, in one or more embodiments.

In one or more embodiments, the streaming of 360 video is able to use the ABR methods disclosed herein, with each layer carrying 360 video content of full resolution of 360×180 degree for instance. However, there is relatively greater use of transmission bandwidth and decoder processing resource since the typical FOV angles are only around 100×60 degree, in one or more embodiments. That is, only around 10% received data is for instance actually used on the client side for typical 360 video rendering and display of a selected viewing direction, in one or more embodiments. Therefore, in accordance with inventive concepts disclosed herein, ABR streaming solutions for 360 video are provided with efficient use of transmission bandwidth and decoder resource usage, in one or more embodiments.

Systems and methods of various 360 degree viewport based streaming are provided in the present disclosure for efficient use of bandwidth and decoder resources for 360 video streaming. In one or more embodiments, the 360 degree viewport based streaming system provides high resolution video at a primary viewing direction within typical FOV angles (e.g. 100×60 degree). In one or more embodiments, the 360 degree viewport based streaming system provides low resolution of video for other viewing directions to reduce bandwidth and decoder resource usage. In one or more embodiments, the 360 degree viewport based streaming system is capable of rendering 360 video at any viewing direction to enable graceful switching of viewport so that a client can change viewing direction at any time with a corresponding bitstream switch occurring at IDU boundaries.

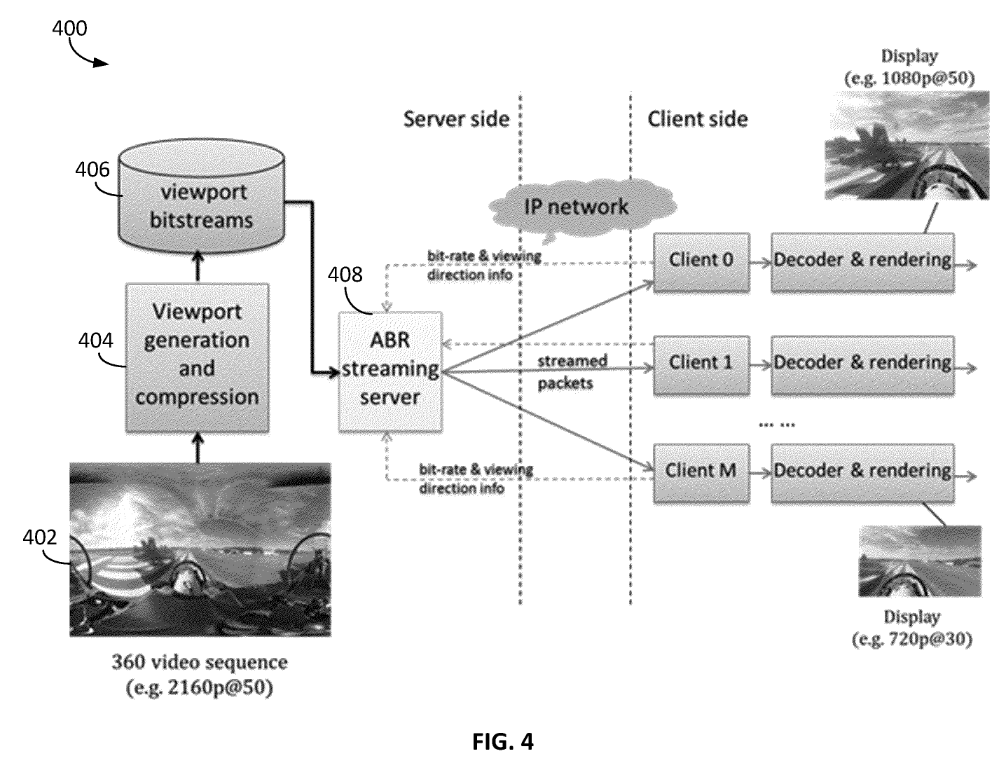

Referring to FIG. 4, a viewport based 360 video streaming system 400 is depicted according to some example embodiments. The viewport based 360 video streaming system 400 includes a server side system and a client side system, in one or more embodiments. The server side system communicates with the client side system through various IP networks, in one or more embodiments. On the server side, a 360 video sequence 402 is converted into viewport representations of selected primary viewing directions, resolutions and/or frame-rates by a viewport generation and compression module 404, in one or more embodiments. The viewport generation and compression module 404 encodes the viewport representations into viewport bitstreams with selected bit-rates, in one or more embodiments. The encoded viewport bitstreams are stored in a storage module 406, in one or more embodiments.

The viewport based 360 video streaming system 400 includes an ABR streaming server 408, in one or more embodiments. The ABR streaming server 408 serves one or more clients (e.g., client 0, client 1 . . . client M) via various possible types of networks, such as an IP network, in one or more embodiments. The ABR streaming server 408 receives bit-rate and/or viewing direction information from the clients, in one or more embodiments. On the client side, each client may have a feedback channel to the server to convey or provide the bandwidth and viewing direction information connected to the client, in one or more embodiments. Based on the feedback information, the server 408 determines and selects the corresponding content from the stored viewport bitstreams and transmits the selected bitstreams to the client, in one or more embodiments. The selected corresponding content for a client may have a primary viewing direction which is closest to the viewing direction used by the client, and consume a transmission bandwidth that is less or equal to the available transmission bandwidth for the client. The client decodes packets to reconstruct the viewport, and renders the video for display according to the selected viewing direction and display resolution, in one or more embodiments. In one or more embodiments, the bandwidth, the selected viewing direction and/or display resolution are different or changes from client to client and/or from time to time.

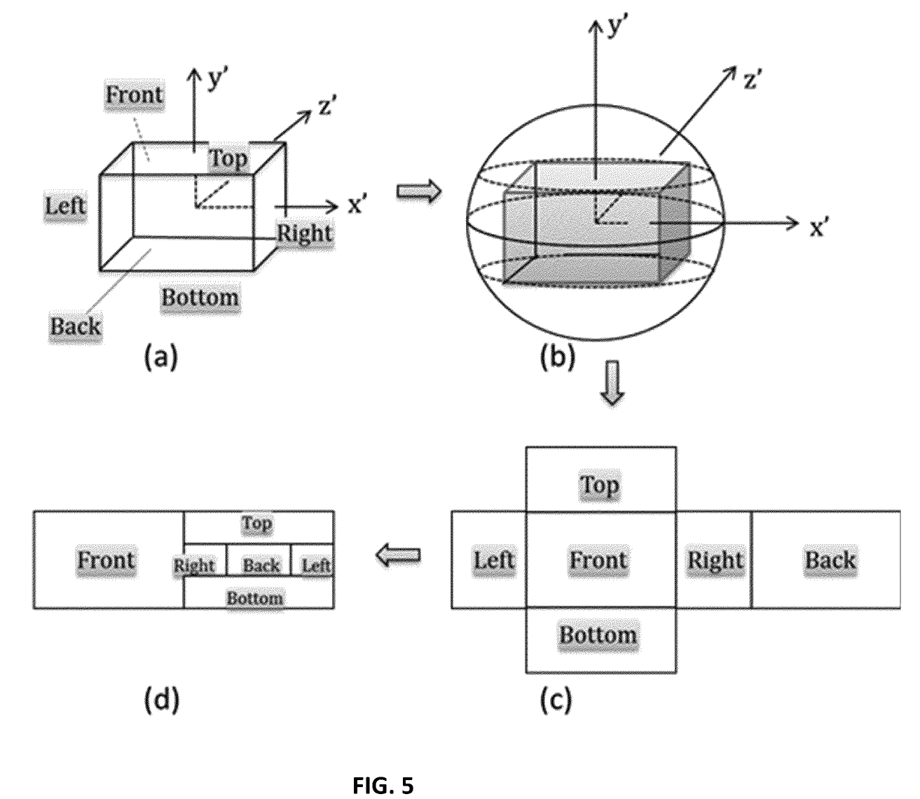

Referring to FIG. 5, a rectangular prime projection format for 360 video is depicted according to some example embodiments. Viewport projection formats are designed to allow a viewport to carry 360 video content at a much lower picture resolution than full resolution, in one or more embodiments. As disclosed herein, one such format is a rectangular prime projection format, in one or more embodiments. As shown in (a) of FIG. 5, a rectangular prime has six faces, namely, left, front, right, back, top and bottom, in one or more embodiments. Here, the front face is defined as the face parallel to the x′-y′ plane and with z′>0, and is determined by a selected primary viewing direction, in one or more embodiments. The front face covers a viewing region with FOV angles such as 100×60 degree, in one or more embodiments.

The 360 video is projected to this format by mapping a sphere (360×180 degree) surface to the six faces of rectangular prime as illustrated in (b) and (c) of FIG. 5, in one or more embodiments. Finally, high resolution is kept for the front face (which is centered at the primary viewing direction) and low resolutions are used for other faces in the viewport layout format depicted in (d) of FIG. 5, in one or more embodiments.

With the viewport projection format defined in (d) of FIG. 5, a 360 video content is able to be represented at a significantly lower resolution, and thus consumes a significantly lower bandwidth for transmission and significantly less decoder resources for decoding, in one or more embodiments. For example, if a 360 video (i.e. 360×180 degree) is originally represented by a picture size or resolution of 3840×2160 (4K) in for example the equirectangular projection format, the same content could be represented by a picture size or resolution of 1920×720 in the viewport projection format depicted in (d) of FIG. 5 for a selected primary view direction and typical FOV angles of 100×60 degree, with 960×720 luminance samples (and associated chrominance samples) for the front face/view and 960×720 samples for the rest of the faces/views (5 faces/views) collectively, roughly a factor 6 of reduction in terms of both picture size and bandwidth reduction, in one or more embodiments.

In spite of significantly reduced resolution of viewport projection format, on the client side a client is able to render high fidelity video if the client chooses a viewing direction that is close to or to the same as the selected primary viewing direction of the received viewport stream, in one or more embodiments. Otherwise, low fidelity portion(s) of the video is rendered and displayed before the server switches to a new viewport bitstream (at IDU boundary) whose primary viewing direction matches the newly selected viewing direction by the client, in one or more embodiments.

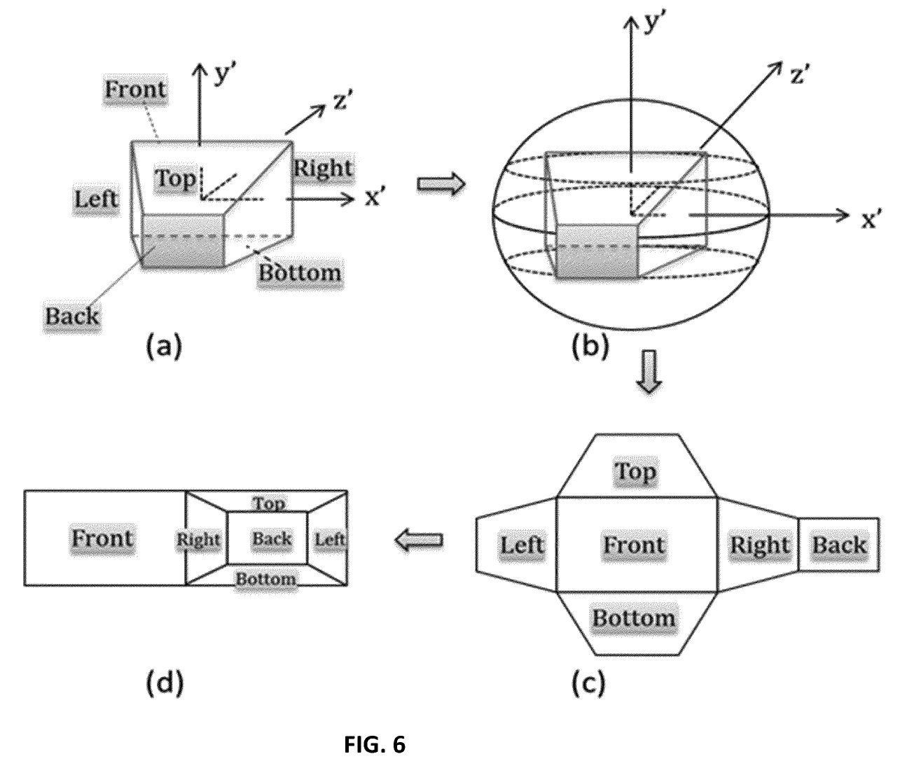

Referring to FIG. 6, a truncated pyramid projection format for 360 viewport is depicted according to some example embodiments. In the truncated pyramid projection format, a 360 video is projected onto two rectangular faces (front and back) and four truncated pyramid faces (left, right, top and bottom), in one or more embodiments. Similar to the rectangular prime projection format, a high resolution (e.g., 3840×2160 (4K)) is kept for the front face (which is cenetred at the selected primary viewing direction) and relatively lower resolutions (e.g., 1920×720) are used for other faces in the truncated pyramid viewport layout as illustratively shown in (d) of FIG. 6, in one or more embodiments. In one or more embodiments, rendering from the truncated pyramid format is more difficult because of complex processing that is to be applied along diagonal face boundaries in this viewport projection format.

The rectangular prime projection format as shown in FIG. 5, and the truncated pyramid projection format as shown in FIG. 6, are for illustration purposes. Various other viewport projection formats are used according to some embodiments. A skilled person in the art shall understand that any suitable viewport projection formats can be adapted in accordance with the present disclosure.

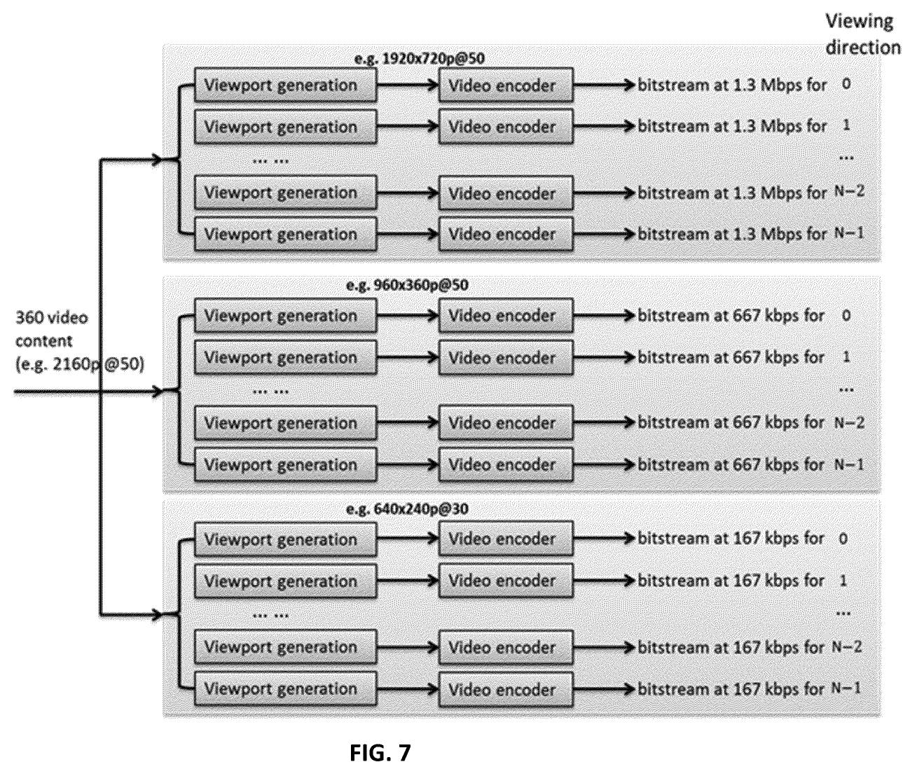

Referring to FIG. 7, a representation of 360 viewport generation and encoding is depicted according to some example embodiments. The viewport generation and compression module 404 as shown in FIG. 4 is implemented to process input videos to generate 360 viewport and to encode the 360 viewport, in one or more embodiments. The input videos have various formats including 360 video projection format, image resolution, frame-rate, etc., in one or more embodiments. For example, the input video as depicted in FIG. 7 has a 2160p@50 sample rate and in equirectangular projection format, in one or more embodiments. In one or more embodiments, the viewport generation and compression module 404 is implemented to convert the incoming 360 video content into viewports of a selected viewport projection format (e.g. rectangular prime or truncated pyramid) for a combination of N selected primary viewing directions and K streaming layers of picture resolutions and frame-rates (e.g., 1920×720@50, 960×360@50 and 640×240@30 in FIG. 7). Finally, the viewport generation and compression module 404 is configured to generate viewports bitstreams by compressing the viewports with a selected video compression format (e.g. HEVC/H.265, MPEG AVC/H.264, VP9, etc.) and at given bit-rates (e.g., 1.3 Mbps, 667 kbps or 167 kbps depending on the picture resolution and/or frame-rate), in one or more embodiments. The compressed viewport bitstreams are stored on the server, in one or more embodiments.

For viewport bitstream generation, the primary viewing directions are selected with a variety of methods, in one or more embodiments. In one or more embodiments, the N primary viewing directions may be uniformly spaced on a 360×180 degree sphere. For example, fixing roll to be 0 and evenly spacing pitch and yaw by every 30 degrees, results in a total of 72 (e.g., N=360/30×180/30=72) viewport bitstreams for a streaming layer, in one or more embodiments. For viewports of different streaming layers, the number of selected primary viewing directions N does not have to be the same, in one or more embodiments.

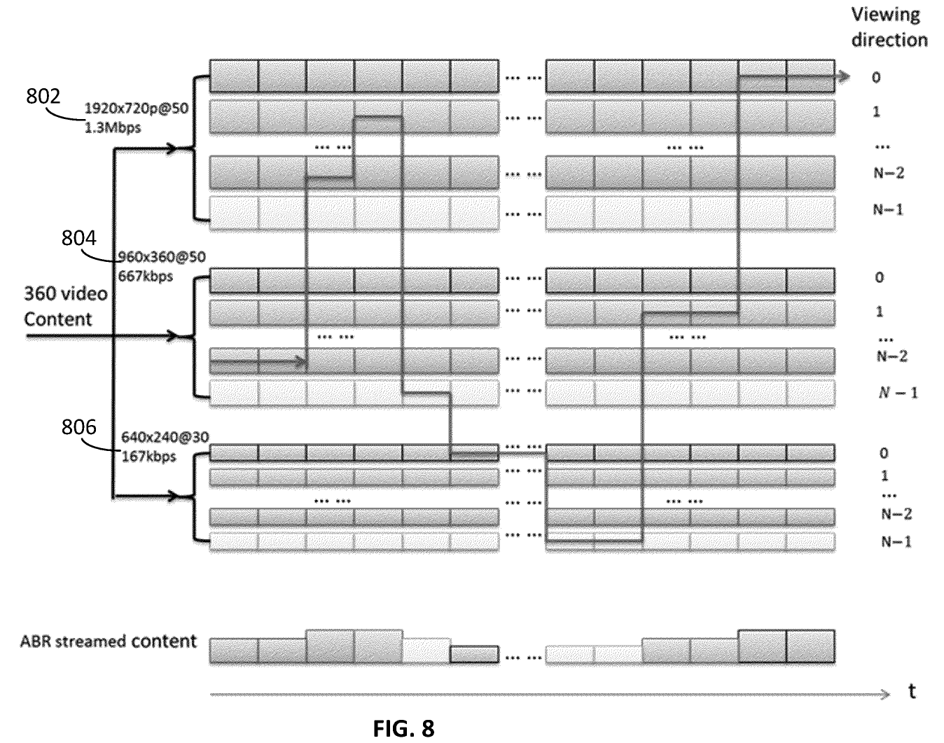

Referring to FIG. 8, a viewport based ABR streaming is depicted according to some example embodiments. The viewport based ABR streaming provides viewport bitstreams to clients based on the bandwidth and viewing directions of the clients, in one or more embodiments. The input 360 video are converted into, e.g., three (or other number of) layers of videos, in one or more embodiments. Each video layer has a different fidelity including resolution, frame rate, bit rate, etc., in one or more embodiments. For example, video layer 802 has a 1920×720p@50 1.3 Mbps format, video layer 804 has a 960×360@50 667 kbps format, video layer 806 has a 640×240@30 167 kbps format, in one or more embodiments. Each video layer includes multiple viewport bitstreams of different primary viewing directions, such as directions 0, 1 . . . N−1, etc., in one or more embodiments.

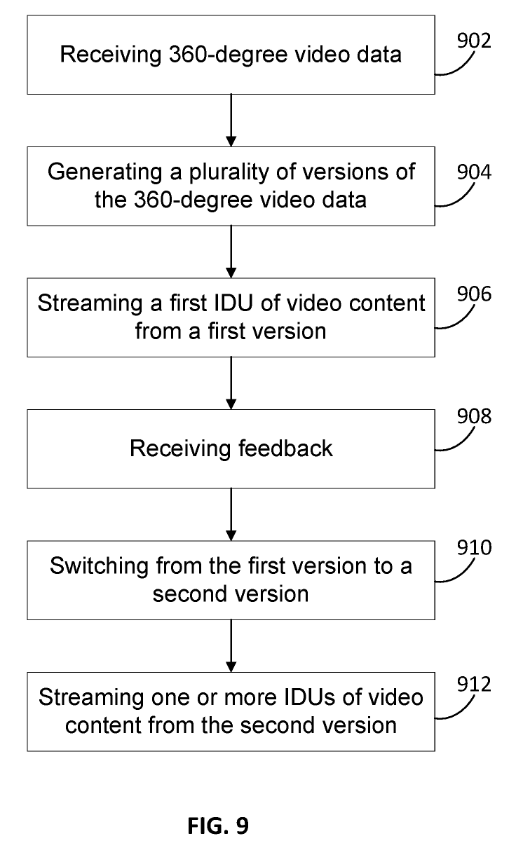

Referring to FIG. 9, a flow chart of a method for streaming 360-degree video data is depicted according to some example embodiments. The method includes receiving 360-degree video data (operation 902), generating a plurality of versions of the 360-degree video data (operation 904), streaming a first independently decodable unit (IDU) of video content (operation 906), receiving feedback (operation 908), switching to a second version of the plurality of versions based on the feedback (operation 910), and streaming one or more independently decodable units (IDUs) of video content from the second version (operation 912).

At operation 902, 360-degree video data is received from a 360-degree a video capturing system, in one or more embodiments, e.g., in real time as the video data is captured, or in near real time. In one or more embodiments, the 360-degree video data is received from a storage device, such as a buffering or temporary storage device. One or more viewport engines receive the 360-degree video data, in one or more embodiments. The 360-degree video data represents 360-degree views in time series, captured from a central point of the video capturing system, in one or more embodiments.

At operation 904, a plurality of versions of the 360-degree video data is generated using the received 360-degree video data, in one or more embodiments. The one or more viewport engines generate the plurality of versions of the 360-degree video data, in one or more embodiments. In one or more embodiments, each version is generated according to a primary viewing direction and a video fidelity. In one or more embodiments, the video fidelity is indicated by a video bitrate, frame-rate and video resolution. For example, a first version is generated for a first primary viewing direction (e.g., yaw=0, pitch=0 and roll=0 degree). The first version is generated with a first video fidelity including a video resolution 1920×720, a frame-rate 50 frames/sec and a video bitrate of 1.3 Mbps. A second version is generated for a second primary viewing direction (e.g., yaw=30, pitch=0 and roll=0 degree). The second version is generated with a second video fidelity including a video resolution 960×360, a frame-rate 50 frames/sec and a video bitrate of 667 Kbps. In one or more embodiments, each version includes a plurality of IDUs.

At operation 906, a first IDU of video content is streamed by a streaming server from a first version of the plurality of versions of the 360-degree video data to a client, in one or more embodiments. In one or more embodiments, the streaming server streams IDUs in a time series and selects each IDU for streamlining based on a current bandwidth and a viewing direction. The first IDU of video content is rendered at the client, in one or more embodiments. In one or more embodiments, the first IDU is selected based on a default viewing direction before receiving any feedback from the client. In one or more embodiments, the first IDU is selected based on a previous feedback including a viewing direction. The first version has a primary viewing direction including a first viewing direction, in one or more embodiments.

At operation 908, the streaming server receives feedback according to the rendering at the client, in one or more embodiments. The feedback is indicative of an update in viewing direction to a second viewing direction, in one or more embodiments. In one or more embodiments, the feedback is generated by a client input. In one or more embodiments, the feedback is generated by detecting a client switching a viewing direction (e.g., when a client wears an AR/VR Head Mounted Display). In one or more embodiments, the feedback is conveyed in real time or near real time. In one or more embodiments, the feedback is generated in response to detecting a change to a current bandwidth.

At operation 910, responsive to the update in viewing direction, the first version of the plurality of versions of the 360-degree video data is dynamically switched to a second version of the plurality of versions of the 360-degree video data, in one or more embodiments. The streaming server selects and/or switches to the second version according to the received feedback, in one or more embodiments. The second version has a primary viewing direction which is closest to the second viewing direction, in one or more embodiments. In one or more embodiments, responsive to an update in available or allocated bandwidth, the first version is dynamically switched to a second version, which has a bitrate supported by the updated bandwidth. In one or more embodiments, responsive to an update in both viewing direction and bandwidth, the first version is dynamically switched to a second version, which has the primary viewing direction closest to the second viewing direction and a bitrate supported by the updated bandwidth.

At operation 912, one or more IDUs are streamed by the streaming server from the second version of the plurality of versions to the client, in one or more embodiments. The one or more IDUs are streamed according to the sequence relative to the first IDU, in one or more embodiments. In one or more embodiments, the streaming server tracks the sequence of IDUs sent, and identifies the next IDU in the sequence from the second version when switching over. In one or more embodiments, the sequence is an index-based system. In one or more embodiments, the sequence is based on timestamps of the video. In one or more embodiments, each version has a corresponding IDU of the same index/timestamp. In one or more embodiments, when a version has no IDU at a particular index/timestamp in the sequence to switch/skip to, the streaming server skips/switches to the next available or suitable IDU within the version.

The viewport based ABR streaming allows the viewers to select directions for viewing and to switch views in real time or near real time between different directions, in one or more embodiments. In one or more embodiments, the viewport based ABR streaming switches views at boundaries of IDUs. The arrow line in FIG. 8 illustrates an example path of the switching between viewport bitstreams (sometime referred herein to as versions of the 360-degree video data), the switching based on network conditions and/or viewing direction changes, in one or more embodiments. The ABR streaming system automatically selects suitable viewport bitstreams according to network conditions, in one or more embodiments. The ABR streaming system receives instructions or feedback from the viewer/client and/or network, indicative of desired or appropriate viewing directions and/or video resolutions, in one or more embodiments. The ABR streaming system adjusts the streaming path according the instructions/feedback, in one or more embodiments. The view path is switched simultaneously as feedback is received regarding the viewer switching to a different viewing direction, in one or more embodiments. If a client changes viewing direction in the middle of an IDU, a low quality of rendered video is displayed (rendered using low resolution information in that IDU corresponding to the viewing direction(s) being switch to) until the end of the current IDU, before high quality rendered video from a next IDU from a new viewport bitstream is resumed, because switching to the new viewport stream that matches with the newly selected viewing direction (by the client) would occur at the next IDU boundary (e.g., at the earliest), in one or more embodiments.

The streamed content as depicted in the bottom portion of FIG. 8 is made up of IDUs from e.g. three layers of viewport streams of different viewing directions, in one or more embodiments. In one or more embodiments, the ABR system switches the viewport bitstream only due to a change in available or allocated bandwidth (data transmission bit-rate) (e.g., due to network conditions), or only due to a change in viewing direction (e.g., triggered by the client), or due to a concurrent change in bandwidth and in viewing direction, depending on the bandwidth and viewing direction feedback information provided by the client device, client and/or network. In one of more embodiments, bandwidth of a network is changed in various network conditions, such as overloaded network, increase demand of network resources, bottleneck on certain nodes in network pathways, failure of network devices. In one or more embodiments, the bandwidth change is detected by determining reduced number of acknowledgement packages which indicate successful receipt at the receiving end, or increased requests to resent data due to dropped packets.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

Those of skill in the art would appreciate that the various illustrative blocks, modules, elements, components, and methods described herein may be implemented as electronic hardware, computer software, or combinations of both. To illustrate this interchangeability of hardware and software, various illustrative blocks, modules, elements, components, and methods have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “example” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

We claim:

1. A system for streaming 360-degree video data, comprising:
one or more viewport engines configured to:
receive 360-degree video data; and
generate a plurality of versions of the 360-degree video data, each version having a corresponding primary viewing direction, each version comprising independently decodable units (IDUs) of video data arranged according to a sequence, and having image resolution for the corresponding primary viewing direction that is higher than image resolutions for other viewing directions; and
a streaming server configured to:
stream a first IDU of video content from a first version of the plurality of versions of the 360-degree video data to a client for rendering at the client, the first version having a primary viewing direction comprising a first viewing direction;
receive feedback according to the rendering at the client, the feedback indicative of an update in viewing direction to a second viewing direction; and
responsive to the update in viewing direction, dynamically switch to a second version of the plurality of versions that has a primary viewing direction comprising the second viewing direction, to stream one or more IDUs from the second version to the client, the one or more IDUs streamed according to the sequence relative to the first IDU.

2. The system of claim 1, wherein the one or more viewport engines are configured to generate IDUs of the first and second versions for streaming at a first bit rate.

3. The system of claim 2, wherein the first bit rate is a function of an image resolution and a frame rate of the IDUs of the first and second versions.

4. The system of claim 1, wherein the one or more viewport engines are configured to generate the plurality of versions of the 360-degree video data by generating a first plurality of versions according to a first bit rate for streaming, and a second plurality of versions according to a second bit rate for streaming.

5. The system of claim 4, wherein the streaming server is further configured to detect a change in network condition, and to dynamically switch from the first version to the second version responsive to the detected change in network condition, wherein the first version is from the first plurality of versions, and the second version is from the second plurality of versions.

6. The system of claim 4, wherein the streaming server is further configured to detect a change in network condition, and to dynamically switch from the second version to a third version, responsive to the detected change in network condition, wherein the second version is from the first plurality of versions, and the third version is from the second plurality of versions, and the second and third versions each has a primary viewing direction comprising the second viewing direction.

7. The system of claim 1, wherein each IDU of the first version comprises video data for which a typical field-of-view (FOV) angle centered around the corresponding primary viewing direction has a first image resolution, and video data for other viewing directions each has an image resolution that is lower than the first image resolution.

8. The system of claim 1, further comprising one or more storage devices configured to store the generated plurality of versions of the 360-degree video data, wherein the streaming server is further configured to retrieve the first IDU from the one or more storage devices to stream to the client.

9. A method for streaming 360-degree video data, comprising:
receiving 360-degree video data;
generating a plurality of versions of the 360-degree video data, each version having a corresponding primary viewing direction, each version comprising independently decodable units (IDUs) of video data arranged according to a sequence, and having image resolution for the corresponding primary viewing direction that is higher than image resolutions for other viewing directions;
streaming, by a streaming server, a first IDU of video content from a first version of the plurality of versions of the 360-degree video data to a client for rendering at the client, the first version having a primary viewing direction comprising a first viewing direction;
receiving, by the streaming server, feedback according to the rendering at the client, the feedback indicative of an update in viewing direction to a second viewing direction; and
responsive to the update in viewing direction, dynamically switching to a second version of the plurality of versions that has a primary viewing direction comprising the second viewing direction, to stream one or more IDUs from the second version to the client, the one or more IDUs streamed according to the sequence relative to the first IDU.

10. The method of claim 9, further comprising generating IDUs of the first and second versions for streaming at a first bit rate.

11. The method of claim 10, wherein the first bit rate is a function of an image resolution and a frame rate of the IDUs of the first and second versions.

12. The method of claim 9, wherein generating the plurality of versions of the 360-degree video data comprises generating a first plurality of versions according to a first bit rate for streaming, and a second plurality of versions according to a second bit rate for streaming.

13. The method of claim 12, further comprising detecting a change in network condition, and dynamically switching from the first version to the second version responsive to the detected change in network condition, wherein the first version is from the first plurality of versions, and the second version is from the second plurality of versions.

14. The method of claim 12, further comprising detecting a change in network condition, and dynamically switching from the second version to a third version, responsive to the detected change in network condition, wherein the second version is from the first plurality of versions, and the third version is from the second plurality of versions, and the second and third versions each has a primary viewing direction comprising the second viewing direction.

15. The method of claim 9, wherein each IDU of the first version comprises video data for which a typical field-of-view (FOV) angle centered around the corresponding primary viewing direction has a first image resolution, and video data for other viewing directions each has an image resolution that is lower than the first image resolution.

16. The method of claim 9, further comprising storing the generated plurality of versions of the 360-degree video data, and retrieving the first IDU from the one or more storage devices to stream to the client.

17. One or more computer-readable storage media having instructions stored therein that, when executed by at least one processor, cause the at least one processor to perform operations comprising:
receiving 360-degree video data;
generating a plurality of versions of the 360-degree video data, each version having a corresponding primary viewing direction, each version comprising independently decodable units (IDUs) of video data arranged according to a sequence, and having image resolution for the corresponding primary viewing direction that is higher than image resolutions for other viewing directions;
streaming a first IDU of video content from a first version of the plurality of versions of the 360-degree video data to a client for rendering at the client, the first version having a corresponding primary viewing direction comprising a first viewing direction;
receiving feedback according to the rendering at the client, the feedback indicative of an update in viewing direction to a second viewing direction; and
responsive to the update in viewing direction, dynamically switching to a second version of the plurality of versions that has a primary viewing direction comprising the second viewing direction, to stream one or more IDUs from the second version to the client, the one or more IDUs streamed according to the sequence relative to the first IDU.

18. The one or more computer-readable storage media of claim 17, wherein the at least one processor further performs operations comprising generating IDUs of the first and second versions for streaming at a first bit rate.

19. The one or more computer-readable storage media of claim 18, wherein the first bit rate is a function of an image resolution and a frame rate of the IDUs of the first and second versions.

20. The one or more computer-readable storage media of claim 17, wherein generating the plurality of versions of the 360-degree video data comprises generating a first plurality of versions according to a first bit rate for streaming, and a second plurality of versions according to a second bit rate for streaming.
